(19) United States
(12) Patent Application Publication
(10) Pub. No.: US 2020/0191114 A1
(43) Pub. Date: Jun. 18, 2020

(54) SYSTEMS, APPARATUSES AND DEVICES FOR HARVESTING ENERGY FROM WIND

(71) Applicant: Dayke Leon Martinez, Oranjestad (AW)

(72) Inventor: Dayke Leon Martinez, Oranjestad (AW)

(21) Appl. No.: 16/717,355

(22) Filed: Dec. 17, 2019

Related U.S. Application Data
(60) Provisional application No. 62/781,585, filed on Dec. 18, 2018.

(51) Int. Cl. F03D 3/02; F03D 3/00

(52) U.S. Cl. CPC F03D 3/02; F03D 3/005

(57) ABSTRACT

Disclosed herein is a windmill for harvesting energy from wind. Accordingly, the windmill may include a rotor assembly and a panel. Further, the rotor assembly may include a rotor shaft and a plurality of blades disposed on the rotor shaft. Further, the rotor shaft may be rotatable. Further, the panel may be disposed proximal to the rotor assembly. Further, a curvature of the panel may be configured to accelerate flow of a wind. Further, a surface of the panel may include a wind interceptor portion and a wind accelerator portion. Further, a first flow of the wind over the wind interceptor portion may be lesser than a second flow of the wind over the wind accelerator portion. Further, the rotor assembly may be associated with the wind accelerator portion. Further, a blade of the plurality of blades intercepts the second flow of the wind.

### RELATED APPLICATION(S)

Under provisions of 35 U.S.C. § 119e, the Applicant(s) claim the benefit of U.S. provisional application No. 62/781,585 filed Dec. 18, 2018, which is incorporated herein by reference.

### TECHNICAL FIELD

Generally, the present disclosure relates to the wind turbines. More specifically, the present disclosure relates to systems, apparatuses and devices for harvesting energy from wind.

### BACKGROUND

With a continuous increase in global energy demands, rapid depletion of non-renewable sources of energy, and increasing demands to move towards greener energy sources, the adoption of renewable sources of energy is on the rise. Amongst the renewable sources of energy, wind energy, harvested through wind-turbines in windmills is one of the most prevalently used sources of energy.

Accordingly, multiple configurations of windmill designs are in use, each with unique characteristics and advantages.

However, most existing windmill designs operationally require a large operational area for installation and operation.

Further, most windmill designs require large blade designs to generate a required rotational energy for operation of a connected generator efficiently, which also leads to fewer windmills being installed in a given area of a windmill farm. Further, high rotational speeds of typical windmills lead to high stress and strain conditions, leading to easy wear and tear.

Further, large and complex designs of typical windmills usually require specialized equipment and machinery for transportation and installation.

Therefore, there is a need for improved systems, apparatuses and devices for harvesting energy from wind that may overcome one or more of the above-mentioned problems and/or limitations.

### BRIEF SUMMARY

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a windmill for harvesting energy from wind, in accordance with some embodiments. Accordingly, the windmill may include at least one rotor assembly and at least one panel.

Further, the at least one rotor assembly may include a rotor shaft and a plurality of blades disposed on the rotor shaft. Further, the rotor shaft may be rotatable.

Further, the at least one panel may be disposed proximal to the at least one rotor assembly. Further, a curvature of the at least one panel may be configured to accelerate flow of a wind. Further, at least one surface of the at least one panel may include a wind interceptor portion and at least one wind accelerator portion. Further, a first flow of the wind over the wind interceptor portion may be lesser than a second flow of the wind over the at least one wind accelerator portion. Further, the at least one rotor assembly may be associated with the at least one wind accelerator portion. Further, at least one blade of the plurality of blades intercepts the second flow of the wind.

Further, disclosed herein is a windmill for harvesting energy from wind, in accordance with some embodiments. Accordingly, the windmill may include at least one rotor assembly and at least one panel.

Further, the at least one rotor assembly may include a rotor shaft and a plurality of blades disposed on the rotor shaft. Further, the rotor shaft may be rotatable.

Further, the at least one panel movably disposed proximal to the at least one rotor assembly. Further, the at least one panel arranged in at least one panel configuration. Further, the at least one panel configuration may include an enclosure. Further, the at least one rotor assembly may be disposed within the enclosure. Further, a curvature of the at least one panel may be configured to accelerate flow of a wind. Further, at least one surface of the at least one panel may include a wind interceptor portion and at least one wind accelerator portion. Further, the at least one panel may be configured to move through a plurality of panel positions. Further, a panel position of the plurality of panel positions aligns the wind interceptor portion along a direction of the flow of the wind. Further, the at least one surface area may include at least one surface opening proximal to the at least one wind accelerator region. Further, a first flow of the wind over the wind interceptor portion may be lesser than a second flow of the wind over the at least one wind accelerator portion. Further, the at least one rotor assembly may be associated with the at least one wind accelerator portion. Further, at least one blade of the plurality of blades intercepts the second flow of the wind through the at least one surface opening.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is a windmill for harvesting energy from wind, in accordance with some embodiments.

FIG. 2 is a top view of a windmill, in accordance with some embodiments.

FIG. 3 is a top view of a windmill with at least one gap, in accordance with some embodiments.

FIG. 4 is a top front perspective view of a windmill, in accordance with some embodiments.

FIG. 5 is a top perspective view of a windmill, in accordance with some embodiments.

FIG. 6 is a top view of a windmill with a wing-shaped panel, in accordance with some embodiments.

FIG. 7 is a top view of a windmill with a cylindrical panel, in accordance with some embodiments.

FIG. 8 is a top view of a windmill with a kite-shaped panel, in accordance with some embodiments.

FIG. 9 is a top view of a windmill with a half airfoil wing panel, in accordance with some embodiments.

FIG. 10 is a top front perspective view of an elongated rotor assembly of a windmill, in accordance with some embodiments.

FIG. 11 is a top front perspective view of an elongated rotor assembly positioned inside a panel, in accordance with some embodiments.

FIG. 12 is a schematic of an energy conversion mechanism, in accordance with some embodiments.

FIG. 13 is an illustration of the installation of a windmill at a windmill farm, in accordance with exemplary embodiments.

FIG. 14 is a windmill for harvesting energy from wind, in accordance with some embodiments.

FIG. 15 is an illustration of an online platform consistent with various embodiments of the present disclosure.

FIG. 16 is a block diagram of a computing device for implementing the methods disclosed herein, in accordance with some embodiments.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of systems, apparatuses and devices for harvesting energy from wind, embodiments of the present disclosure are not limited to use only in this context.

Overview:

The present disclosure may describe systems, apparatuses, and devices for harvesting energy from wind. Further, the disclosed systems, apparatuses and devices may include a wing-shaped windmill. The wing-shaped windmill may include a tower. The tower may extend upwards from a base structure supporting the tower. Further, the tower may envelop, and house one or more components of the windmill. Further, the tower may be shaped as an airfoil wing and may include a leading edge, a trailing edge, two surfaces, and a varying thickness. Further, the tower structure may include maximum thickness corresponding to the airfoil wing shape of the tower extending along the height of the tower. Further, in an embodiment, the tower may be shaped in one or more additional shapes. For instance, the tower may be cylindrical shaped, kite-shaped, shaped like a half-cylinder, and so on. Further, in an embodiment, the tower may include one or more gaps in the structure of the tower, such as to create a tunnel effect. Further, in an embodiment, the tower may be shaped like a pyramid and may be wider at the base, to provide increased structural integrity.

Further, the tower may house one or more rotors. Further, the one or more rotors may include a plurality of blades (and/or scoops or scoop-shaped profiles) connected to the one or more rotors. Further, the plurality of blades (and/or scoops or scoop-shaped profiles) may be configured to lift and rotate through the energy of wind currents, and aid in conversion of wind energy to low-speed rotational energy. The plurality of blades (and/or scoops or scoop-shaped profiles) may include a plurality of surfaces designed to interface with oncoming wind (catch the oncoming wind), and cause the plurality of blades (and/or scoops or scoop-shaped profiles), and subsequently the one or more rotors to rotate. Further, the one or more rotors may be housed inside the tower in a lateral manner sequentially on top of each other along a plurality of parallel planes. Further, a portion of the plurality of blades (and/or scoops or scoop-shaped profiles) corresponding to the one or more rotors may extend outward from an outer surface of the tower. Further, a remaining portion of the plurality of blades (and/or scoops or scoop-shaped profiles), counter-rotating to the portion extending outwards, may remain concealed to minimize drag resistance forces that may be generated. Further, in an embodiment, each of the plurality planes along which the one or more rotors may be housed may correspond to a plurality of the one or more rotors. Accordingly, the plurality of blades (and/or scoops or scoop-shaped profiles) corresponding to the plurality of rotors co-located on a plane may extend outwards along a plurality of opposite outer surfaces of the tower. Further, in an embodiment, only one rotor of the one or more rotors may correspond to a plane.

For instance, the tower may be cylindrical shaped and may include one outer surface. Accordingly, the tower may include one or more rotors (housed sequentially one over the other along a plurality of planes) including a plurality of blades (and/or scoops or scoop-shaped profiles), which may extend outward from an outer surface of the cylindrical tower. Further, if each of the plurality planes along which the one or more rotors are housed corresponds to one or more of the one or more rotors, the plurality of blades (and/or scoops or scoop-shaped profiles) corresponding to the one or more rotors co-located on a plane may extend outwards along the outer surface of the cylindrical tower along diametrically opposite ends. Further, the tower may be shaped as an airfoil wing and may include a leading edge, a trailing edge, two surfaces, and a varying thickness. Further, the tower structure may include maximum thickness corresponding to the airfoil wing shape of the tower extending along the height of the tower. Accordingly, the tower may include one or more rotors (housed sequentially one over the other along a plurality of planes) including a plurality of blades (and/or scoops or scoop-shaped profiles), which may extend outward from an outer surface of the airfoil wing-shaped tower. Further, if each of the plurality planes along which the one or more rotors are housed corresponds to one or more of the one or more rotors, the plurality of blades (and/or scoops or scoop-shaped profiles) corresponding to the one or more rotors co-located on a plane may extend outwards along the two surfaces of the airfoil wing-shaped tower along the maximum thickness. Further, the plurality of blades (and/or scoops or scoop-shaped profiles) may rotate and may act as a stabilizing gyroscopic mass for the tower. Further, each pair of the one or more rotors and plurality of blades (and/or scoops or scoop-shaped profiles) co-located on the plurality of planes may neutralize torque forces acting on the tower through a counter-rotation of the plurality of blades (and/or scoops or scoop-shaped profiles).

Further, the wing-shaped windmill may include one or more drive shafts connected to the one or more rotors. The one or more drive shafts may be configured to transmit the rotational energy of the one or more rotors to a generator. Further, the generator may be configured to convert the rotational energy received through the one or more drive shafts to electrical energy. Further, in an embodiment, the wing-shaped windmill may include an energy storage and transferring mechanism, such as a flywheel connected to the rotors. Accordingly, the one or more rotors may transmit the rotational energy to the energy storage and transferring mechanism, whereupon the energy storage and transferring mechanism may transfer the rotational energy to a singular driveshaft connected to the generator. Further, in an instance, the rotational speed of the one or more rotors may not be adequate to power the generator. Accordingly, the wing-shaped windmill may include a gearbox configured to increase rotational speed from the plurality of rotors to a higher speed, such as in a ratio of 90:1. Accordingly, a low rpm of 16.7 from the one or more rotors may be converted to 1,500 rpm output for the generator.

Further, the generator may be geared and/or direct shaft. Widebody Generators increase angular momentum resulting in structural and generation stability as well as increased leverage for wind force transformed into torque.

Further, the base structure of the wing-shaped windmill may house a plurality of components, such as for ease of access during potential servicing and repair. Further, housing the plurality of components in the base may decrease a structural load on the tower due to reduced mass. For instance, the base structure may include a yaw drive configured to orient the wing-shaped windmill in a manner to allow the plurality of blades (and/or scoops or scoop-shaped profiles) to catch the wind at an appropriate angle to maximize rotational energy, as determined using a wind vane and an anemometer included in the wing-shaped windmill to determine wind speed and wind direction. Further, the base structure may include a yaw motor that may be configured to power the yaw drive. Further, the base structure may house the generator.

Further, the plurality of blades (and/or scoops or scoop-shaped profiles) of the wing-shaped windmill may be retractable and may be retracted inward. For instance, if the wind speed is determined to be more than a pre-determined threshold, as determined through the anemometer, the plurality of blades (and/or scoops or scoop-shaped profiles) may be retracted inwards in the tower to protect the wing-shaped windmill from potential damage. Further, if the wind speed is determined to be less than a pre-determined threshold, as determined through the anemometer, the plurality of blades (and/or scoops or scoop-shaped profiles) may be retracted inwards in the tower to protect the wing-shaped windmill from potential wear and tear.

Further, in an embodiment, the tower of the wing-shaped windmill may be retractable and may be retracted in a downward direction to reduce the height of the tower, such as to protect the tower during extreme weather, or for servicing purposes.

Further, the wing-shaped windmill may include solar panels on external surfaces for additional power generation.

Further, the wing-shaped windmill may be structurally combined and/or integrated with existing and new construction type building(s).

Further, the wing-shaped windmill may be horizontally shaped, or may be inclined to varieties of inclinations of so as to lay, lean, and hang on, to and from existing structures for support, such as under bridges, on top of buildings located in regions with altitude limit or restriction (such as close to airports and airports approach lines) or any other structures.

Further, the windmill may include an elongated rotor. The elongated rotor may include a plurality of elongated blades (and/or scoops or scoop-shaped profiles) extending along the length of the rotor. Further, the elongated rotor may be positioned inside a tower.

Further, the wing-shaped windmill may include a tower. The tower may extend upwards from a base structure supporting the tower. Further, the tower may envelop, and house one or more components of the windmill. Further, the tower may be shaped as half airfoil wing and may include a leading edge, a trailing edge, two surfaces, and a varying thickness. Further, the tower structure may include maximum thickness corresponding to the wing shape of the tower extending along the height of the tower. Further, the tower may house one or more rotors. Further, the one or more rotors may include a plurality of blades (and/or scoops or scoop-shaped profiles) connected to the one or more rotors. Further, the plurality of blades (and/or scoops or scoop-shaped profiles) may be configured to lift and rotate through the energy of wind currents, and aid in conversion of wind energy to low-speed rotational energy. The plurality of blades (and/or scoops or scoop-shaped profiles) may include a plurality of surfaces designed to interface with oncoming wind (catch the oncoming wind), and cause the plurality of blades (and/or scoops or scoop-shaped profiles), and subsequently, the one or more rotors to rotate. Further, the one or more rotors may be housed inside the tower in a lateral manner sequentially on top of each other along a plurality of parallel planes. Further, a portion of the plurality of blades (and/or scoops or scoop-shaped profiles) corresponding to the one or more rotors may extend outward from an outer surface of the tower. Further, a remaining portion of the plurality of blades (and/or scoops or scoop-shaped profiles), counter-rotating to the portion extending outwards, may remain concealed to minimize drag resistance forces that may be generated. Further, each of the plurality planes along which the one or more rotors may be housed may correspond to one rotor. Accordingly, the plurality of blades (and/or scoops or scoop-shaped profiles) corresponding to the plurality of rotors co-located on a plane may extend outwards along an outer surface of the tower.

Further, the windmill may include a tower with a gap. The tower may extend upwards from a base structure supporting the tower. Further, the tower may envelop, and house one or more components of the windmill. Further, the tower may be shaped as an airfoil wing and may include a leading edge, a trailing edge, two surfaces, and a varying thickness. Further, the tower structure may include maximum thickness corresponding to the airfoil wing shape of the tower extending along the height of the tower. Further, the tower may include one or more gaps in the structure of the tower, such as to create a tunnel effect. Further, the tower may include a plurality of blades (and/or scoops or scoop-shaped profiles) corresponding to one or more motors protruding in the one or more gaps. Accordingly, the tunnel effect of the tower may increase wind speed through the one or more gaps, and increase a rotational speed of the one or more rotors corresponding to the plurality of blades (and/or scoops or scoop-shaped profiles) protruding in the one or more gaps, leading to an increased efficiency of the windmill.

Further, the disclosed systems, methods, and apparatus may include a cylindrically shaped windmill. The cylindrical-shaped windmill may include a cylindrical shaped tower including one outer surface. Further, the tower may include one or more rotors (housed sequentially one over the other along a plurality of planes) including a plurality of blades (and/or scoops or scoop-shaped profiles), which may extend outward from an outer surface of the cylindrical tower. Further, if each of the plurality planes along which the one or more rotors are housed corresponds to one or more of the one or more rotors, the plurality of blades (and/or scoops or scoop-shaped profiles) corresponding to the one or more rotors co-located on a plane may extend outwards along the outer surface of the cylindrical tower along diametrically opposite ends of the cylindrical tower.

Further, the disclosed systems, methods, and apparatus may include kite-shaped windmill. The kite-shaped windmill may include a kite-shaped tower including a plurality of outer surfaces. Further, the kite-shaped tower may include one or more rotors (housed sequentially one over the other along a plurality of planes) including a plurality of blades (and/or scoops or scoop-shaped profiles), which may extend outward from an outer surface of the cylindrical tower. Further, if each of the plurality planes along which the one or more rotors are housed corresponds to one or more of the one or more rotors, the plurality of blades (and/or scoops or scoop-shaped profiles) corresponding to the one or more rotors co-located on a plane may extend outwards along the plurality of outer surfaces of the kite-shaped tower, such as along diagonally opposite ends of the kite-shaped tower.

Further, the windmill may be installed on a windmill farm. The windmill farm may include a plurality of wing-shaped mills. In an instance, the windmill farm may include one or more cylindrical-shaped windmills, kite-shaped windmills, and so on. Further, the windmill farm may be located in an area with a desired wind speed, such as in an open area, an urban area, near the sea, and so on. Further, the windmill farm may incorporate an optimum use of land area by allowing a greater expansion of the one or more windmills vertically, causing lesser wind turbulence and fewer disturbances next to and behind each of the plurality of windmills. Further, the windmill farm may incorporate an optimized geometry due to reduced wind flow disturbances by the plurality of windmills allowing for a lighter and denser exploitation of available wind-rich areas.

Further, an energy conversion mechanism associated with the windmill may facilitate the conversion of rotational energy of one or more drive shafts to electrical energy. The windmill may include one or more drive shafts connected to one or more rotors. The one or more drive shafts may be configured to transmit the rotational energy of the one or more rotors to a generator. Further, the generator may be configured to convert the rotational energy received through the one or more drive shafts to electrical energy. Further, in an embodiment, the wing-shaped windmill may include an energy storage and transferring mechanism, such as a flywheel connected to the rotors. Accordingly, the one or more rotors may transmit the rotational energy to the energy storage and transferring mechanism, whereupon the energy storage and transferring mechanism may transfer the rotational energy to a singular driveshaft connected to the generator. Further, in an instance, the rotational speed of the one or more rotors may not be adequate to power the generator. Accordingly, the wing-shaped windmill may include a gearbox configured to increase rotational speed from the plurality of rotors to a higher speed, such as in a ratio of 90:1. Accordingly, a low rpm of 16.7 from the one or more rotors may be converted to 1,500 rpm output for the generator.

Further, the disclosed systems, methods, and apparatus may include a plurality of configurations of the windmill. The configurations may be attached to existing structures. Further, the configurations may include a plurality of gaps and guiding structures. The plurality of guiding structures may be located along a length of the tower of the wing-shaped windmill and may guide oncoming wind into the plurality of gaps, wherein a velocity of the oncoming wind may be increased due to tunnel effect and allow for generation of an increased rotational energy.

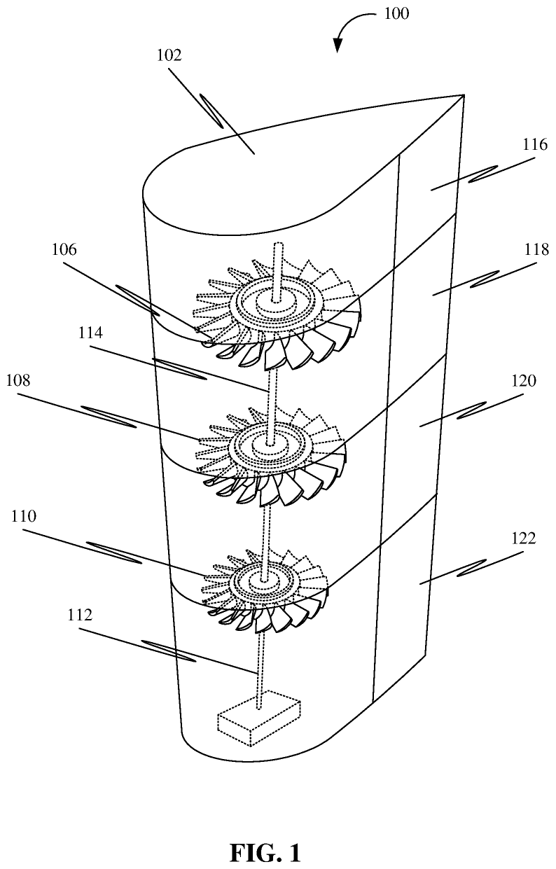

Referring now to figures, FIG. 1 is a windmill 100 for harvesting energy from wind, in accordance with some embodiments. Accordingly, the windmill 100 may include at least one rotor assembly 112 and at least one panel 102.

Further, the at least one rotor assembly 112 may include a rotor shaft 114 and a plurality of blades 106-110 disposed on the rotor shaft 114. Further, the at least one rotor assembly 112 may be made of metal, non-metal, metalloids, etc.

In an exemplary embodiment, the windmill 100 may include a single rotor assembly in the at least one rotor assembly 112. Further, the windmill 100 with the single rotor assembly may be installed at a location with a limited space (such as a top floor of a building). Although, the single rotor assembly may facilitate the harvesting of limited energy from the wind.

In an exemplary embodiment, the at least one rotor assembly 112 may include a plurality of rotor assemblies. Further, the plurality of rotor assemblies may occupy more space as compared to the single rotor assembly. However, the plurality of rotor assemblies may facilitate the harvesting of more energy from the wind as compared to the single rotor assembly. Further, the windmill 100 with the plurality of rotor assemblies may be installed at a location with more space such as a beach, or other open spaces, etc. Further, the rotor shaft 114 may be rotatable.

Further, the at least one panel 102 may be disposed proximal to the at least one rotor assembly 112. Further, the at least one panel 102 may include a physical structure such as, but not limited to, a metallic sheet, or a concrete barrier that may be disposed at a suitable distance proximal to the at least one rotor assembly 112. Further, the suitable distance may be determined on the basis of size of the windmill 100. Further, the suitable distance may range up to 10 meters. Further, the at least one panel 102 may accelerate and redirect the flow of wind to the plurality of blades 106-110 associated with the windmill 100 that may facilitate harvesting more energy from the wind.

Further, the plurality of blades 106-110 may include scoops, and/or scoop shaped profiles that may be configured to lift and rotate in response to push from wind currents.

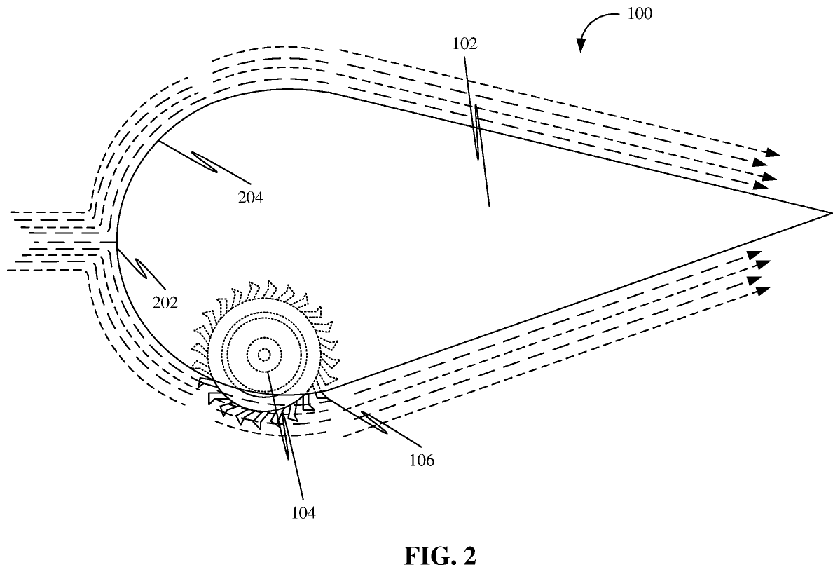

Further, a curvature of the at least one panel 102 may be configured to accelerate flow of a wind. Further, at least one surface of the at least one panel may include a wind interceptor portion 202 (as shown in FIG. 2) and at least one wind accelerator portion 204 (as shown in FIG. 2). Further, a first flow of the wind over the wind interceptor portion may be lesser than a second flow of the wind over the at least one wind accelerator portion. Further, the at least one rotor assembly may be associated with the at least one wind accelerator portion. Further, at least one blade of the plurality of blades 106-110 may intercept the second flow of the wind.

Further, in some embodiments, the at least one panel 102 may be movably disposed proximal to the at least one rotor assembly 112. Further, the at least one panel 102 may be configured to arrange in a shut arrangement and an open arrangement. Further, the at least one blade may not intercept the second flow of the wind in the shut arrangement. Further, the shut arrangement may correspond to a position of the plurality of blades 106-110 retracted into the at least one panel 102. Further, the at least one blade may intercept the second flow of the wind in the open arrangement.

Further, in some embodiments, the at least one surface may include at least surface opening proximal to the at least one wind accelerator portion 204. Further, the at least one rotor assembly 112 may partially protrude from the at least one surface opening exposing at least one first blade of the plurality of blades 106-110 to the flow of the wind and concealing at least one second blade of the plurality of blades 106-110 from the flow of the wind. Further, the at least one first blade may intercept the second flow of the wind. Further, the at least one second blade may not intercept the second flow of the wind.

Further, in some embodiments, the at least one panel 102 may be movably disposed proximal to the at least one rotor assembly 112. Further, the at least one panel 102 may be configured to move through a plurality of panel positions. Further, a panel position of the plurality of panel positions may align the wind interceptor portion 202 along a direction of the flow of the wind. Further, a position of the plurality of positions may include orientation of the at least one panel 102 along with the wind direction that may facilitate achieving higher rotational speeds by the at least one rotor assembly 112. Further, the higher rotational speeds of the at least one rotor assembly 112 may facilitate harvesting more energy from the wind.

Further, in some embodiments, the rotor shaft 114 may include a plurality of rotor shaft sections. Further, each rotor shaft section of the plurality of rotor shaft sections may be retractable. Further, the each rotor shaft section may be configured to transition between an extended position and a retracted position. Further, the at least one blade may be disposed on the each rotor shaft section. Further, the extended position may include the each rotor shaft section in an extended position that may increase length of the rotor shaft 114. Further, the retracted position may include the each rotor shaft section in a retracted position that may decrease length of the rotor shaft 114. Further, in the extended position the rotor shaft 114 may capture wind flowing at a higher altitude.

Further, in some embodiments, the at least one panel 102 may include a plurality of panel sections 116-122. Further, each panel section of the plurality of panel sections 116-122 may be retractable. Further, the each panel section may be configured to transition between an extended position and a retracted position. Further, the extended position may include the each panel section in an extended position that may increase length of the at least one panel 102. Further, the retracted position may include the each panel section in a retracted position that may decrease length of the at least one panel 102.

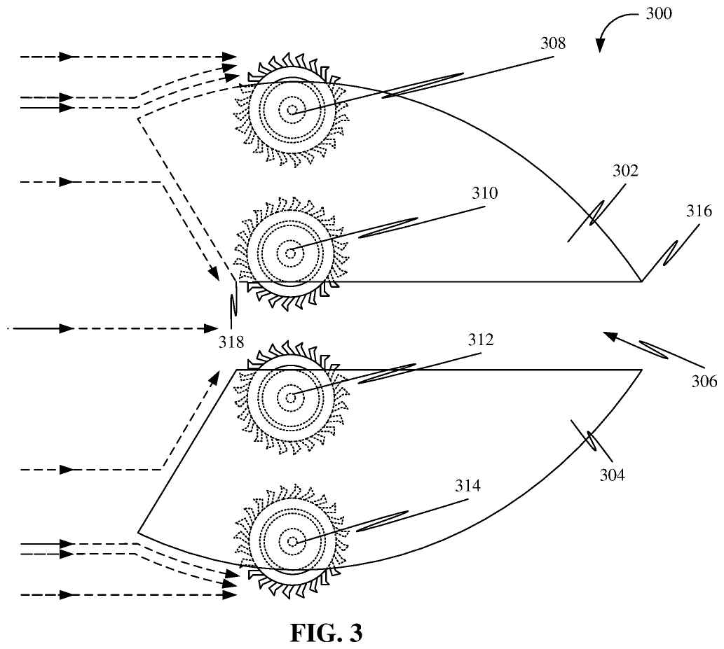

Further, in some embodiments, the at least one panel 102 may include a first panel 302 (as shown in FIG. 3) and a second panel 304 (as shown in FIG. 3). Further, the first panel 302 disposed proximal to the second panel 304 may include at least one panel gap 306 (as shown in FIG. 3). Further, the flow of the wind may accelerate in the at least one panel gap 306 due to tunnel effect. Further, the at least one gap 306 may be associated with the at least one surface.

Further, in some embodiments, the at least one panel 102 may include a curved surface and an interior space formed by the at least one panel 102. Further, the at least one rotor assembly 112 may be disposed within the interior space. Further, the interior space may may be shaped as one or more of a cylindrical-shape, a spherical-shape, a wing-shape, etc. Further, the curved surface may include at least one surface opening proximal to the at least one wind accelerator portion. Further, the at least one blade may protrude from the at least one surface opening to intercept the second flow of the wind.

Further, in some embodiments, the rotor shaft 114 of a first rotor assembly of the at least one rotor assembly 112 associated with a first wind accelerator portion of the at least one wind accelerator portion 204 may be configured to rotate in a clockwise direction. Further, the rotor shaft 114 of a second rotor assembly of the at least one rotor assembly 112 associated with a second wind accelerator portion of the at least one wind accelerator portion may be configured to rotate in a counter-clockwise direction.

Further, in some embodiments, the at least one rotor assembly 112 may be configured to orient in at least one orientation. Further, the at least one orientation aligns a wind impact portion of the plurality of blades 106-110 perpendicular to the second flow of the wind. Further, the perpendicular orientation of the at least one rotor assembly 112 may facilitate achieving higher rotational speed. Further, the higher rotational speed of the at least one rotor assembly 112 may facilitate harvesting more energy from the second flow of the wind.

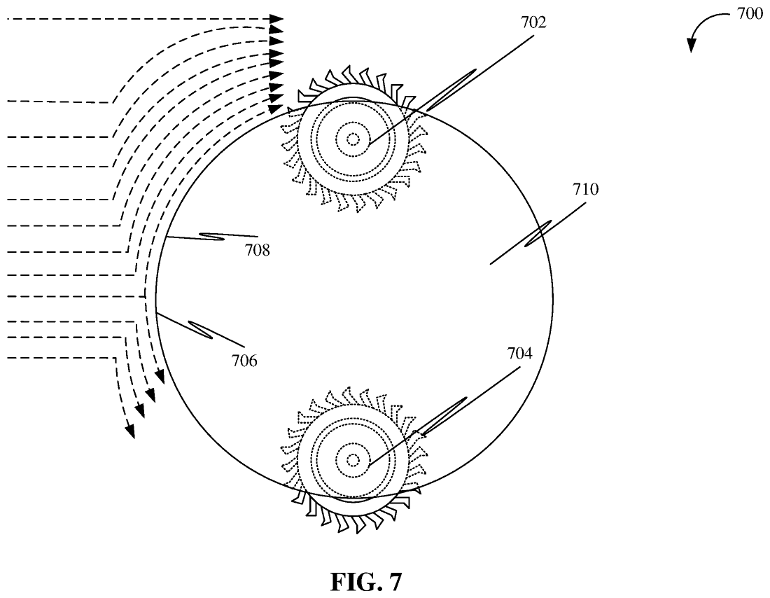

Further, in some embodiments, the at least one panel 102 may be configured in a cylindrical configuration (as shown in FIG. 7). Further, the at least one surface may include at least one airfoil surface. Further, the flow of the wind accelerates over the at least one airfoil surface.

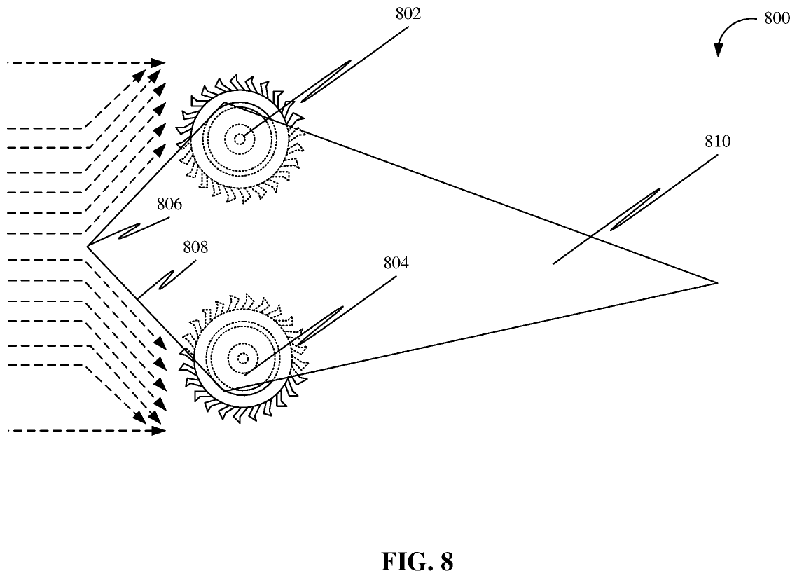

Further, in some embodiments, the at least one panel 102 may be configured in a kite-shaped configuration (as shown in FIG. 8). Further, the at least one surface may include at least one airfoil surface. Further, the flow of the wind accelerates over the at least one airfoil surface.

Further, in some embodiments, the at least one panel 102 may be configured in a wing-shaped configuration. Further, the at least one surface may include at least one airfoil surface. Further, the flow of the wind accelerates over the at least one airfoil surface.

FIG. 2 is a top view of a windmill 100, in accordance with some embodiments. Accordingly, the at least one panel 102 may be disposed proximal to the at least one rotor assembly. Further, a curvature of the at least one panel 102 may be configured to accelerate the flow of a wind. Further, at least one surface of the at least one panel 102 may include a wind interceptor portion 202 and at least one wind accelerator portion 204. Further, a first flow of the wind over the wind interceptor portion 202 may be lesser than a second flow of the wind over the at least one wind accelerator portion 204. Further, the at least one rotor assembly 112 may be associated with the at least one wind accelerator portion 204. Further, at least one blade of the plurality of blades 106-110 may intercept the second flow of the wind.

FIG. 3 is a top view of a windmill 300 with at least one gap 306, in accordance with some embodiments. Accordingly, the windmill 300 may include a at least one panel. Further, the at least one panel may include a plurality of rotor assemblies 308-314. Further, the plurality of rotor assemblies may include a rotor and a plurality of blades (and/or scoops or scoops shaped profiles). Further, the at least one panel may include a first panel 302 and a second panel 304. Further, the at least one panel may include a leading edge 316, a trailing edge 318, two surfaces, and a varying thickness. Further, the at least one panel 102 associated with the windmill 100 may include a first panel 302 and a second panel 304. Further, the first panel 302 disposed proximal to the second panel 304 may include at least one panel gap 306. Further, the flow of the wind may accelerate in the at least one panel gap 306 due to tunnel effect. Further, the at least one gap 306 may be associated with the at least one surface. Further, the tunnel effect may increase wind speed through the at least one gap 306, and increase a rotational speed of the rotors corresponding to the plurality of blades (and/or scoops or scoop-shaped profiles) protruding in the at least one gap 306, leading to an increased efficiency of the windmill 300.

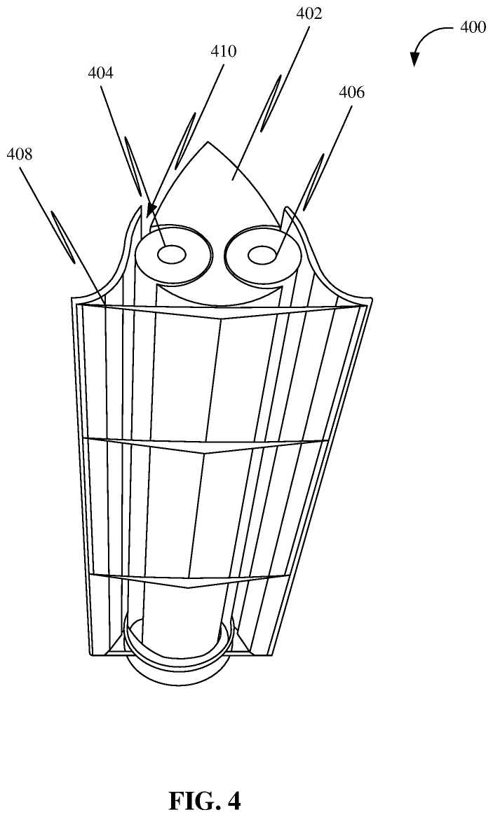

FIG. 4 is a top front perspective view of a windmill 400, in accordance with some embodiments. Accordingly, the windmill 400 may include at least one rotor assembly and a panel 402. Further, the at least one rotor assembly may include a first rotor assembly 404 and a second rotor assembly 406. Further, the at least one rotor assembly may include a rotor and a plurality of blades (and/or scoops or scoops shaped profiles). Further, the windmill 400 may include a guiding structure 408 (such as metallic sheet) located along the length of the panel 402. Further, the guiding structure 408 may guide the oncoming wind into the plurality of gaps 410, wherein a velocity of the oncoming wind may be increased due to tunnel effect and allow for generation of an increased rotational energy.

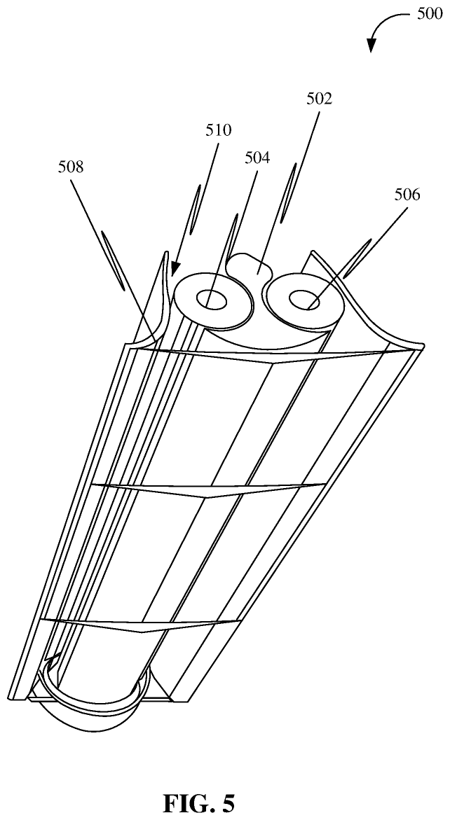

FIG. 5 is a top perspective view of a windmill 500, in accordance with some embodiments. Accordingly, the windmill 500 may include at least one rotor assembly and a panel 502. Further, the at least one rotor assembly may include a first rotor assembly 504 and a second rotor assembly 506. Further, the at least one rotor assembly may include a rotor and a plurality of blades (and/or scoops or scoops shaped profiles). Further, the windmill 500 may include a guiding structure 508 (such as metallic sheet) located along the length of the panel 402. Further, the guiding structure 508 may guide the oncoming wind into the plurality of gaps 510, wherein a velocity of the oncoming wind may be increased due to tunnel effect and allow for generation of an increased rotational energy.

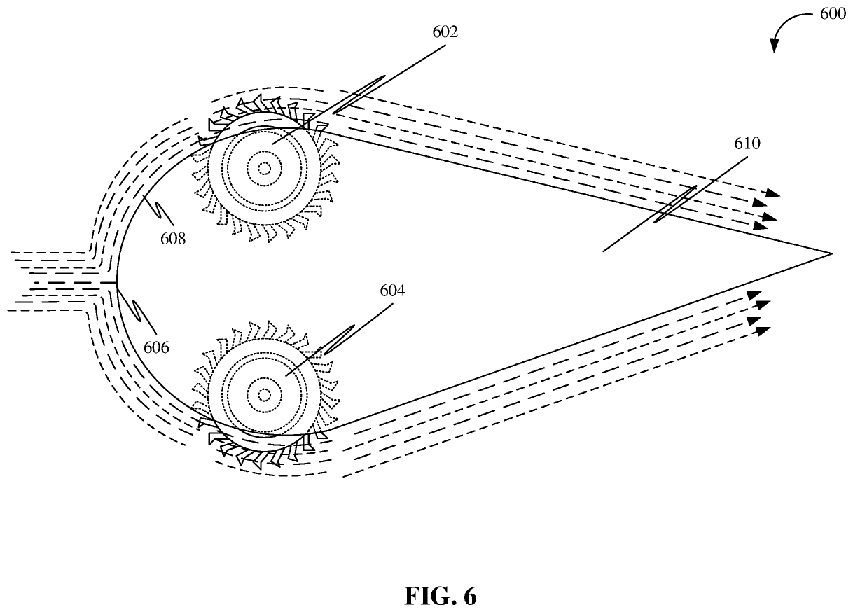

FIG. 6 is a top view of a windmill 600 with a wing shaped panel 610, in accordance with some embodiments. Accordingly, the windmill 600 may include at least one rotor assembly and a wing shaped panel 610. Further, the at least one rotor assembly may include a first rotor assembly 602 and a second rotor assembly 604. Further, the at least one rotor assembly may include a rotor shaft, a plurality of blades (and/or scoops or scoops shaped profiles). Further, a curvature of the wing shaped panel 610 may be configured to accelerate flow of a wind. Further, the first rotor assembly 602 associated with a first wind accelerator portion of the at least one wind accelerator portion 608 may be configured to rotate in a clockwise direction. Further, the second rotor assembly 604 of the at least one rotor assembly associated with a second wind accelerator portion of the at least one wind accelerator portion may be configured to rotate in a counter-clockwise direction. Further, at least one surface of the wing shaped panel 610 may include a wind interceptor portion 606 and at least one wind accelerator portion 608. Further, a first flow of the wind over the wind interceptor portion 606 may be lesser than a second flow of the wind over the at least one wind accelerator portion 608. Further, the first rotor assembly 602 and the second rotor assembly 604 may partially protrude from at least one surface opening of wing shaped panel 610. Further, the at least one surface opening may be associated with at least one surface proximal to the at least one wind accelerator portion 608.

FIG. 7 is a top view of windmill 700 with a cylindrical panel 710, in accordance with some embodiments. Accordingly, the windmill 700 may include at least one rotor assembly and a cylindrical panel 710. Further, the at least one rotor assembly may include a first rotor assembly 702 and a second rotor assembly 704. Further, the at least one rotor assembly may include a rotor shaft and a plurality of blades (and/or scoops or scoops shaped profiles). Further, a curvature of the cylindrical panel 710 may be configured to accelerate flow of a wind. Further, at least one surface of the cylindrical panel 710 may include a wind interceptor portion 706 and at least one wind accelerator portion 708. Further, a first flow of the wind over the wind interceptor portion 706 may be lesser than a second flow of the wind over the at least one wind accelerator portion 708. Further, the first rotor assembly 702 and the second rotor assembly 704 may partially protrude from at least one surface opening of the cylindrical panel 710. Further, the at least one surface opening may be associated with at least one surface proximal to the at least one wind accelerator portion 708. Further, the first rotor assembly 702 and the second rotor assembly 704 may be located on a plane (such as a plane along diagonally opposite ends of the cylindrical panel 710).

FIG. 8 is a top view of windmill 800 with a kite shaped panel 810, in accordance with some embodiments. Accordingly, the windmill 800 may include at least one rotor assembly and a kite shaped panel 810. Further, the at least one rotor assembly may include a first rotor assembly 802 and a second rotor assembly 804. Further, the at least one rotor assembly may include a rotor shaft and a plurality of blades (and/or scoops or scoops shaped profiles). Further, a curvature of the kite shaped panel 810 may be configured to accelerate the flow of a wind. Further, at least one surface of the kite shaped panel 810 may include a wind interceptor portion 806 and at least one wind accelerator portion 808. Further, a first flow of the wind over the wind interceptor portion 806 may be lesser than a second flow of the wind over the at least one wind accelerator portion 808. Further, the first rotor assembly 802 and the second rotor assembly 804 may partially protrude from at least one surface opening of the kite shaped panel 810. Further, the at least one surface opening may be associated with at least one surface proximal to the at least one wind accelerator portion 808. Further, the first rotor assembly 802 and the second rotor assembly 804 may be located on a plane (such as a plane along diagonally opposite ends of the kite shaped panel 810).

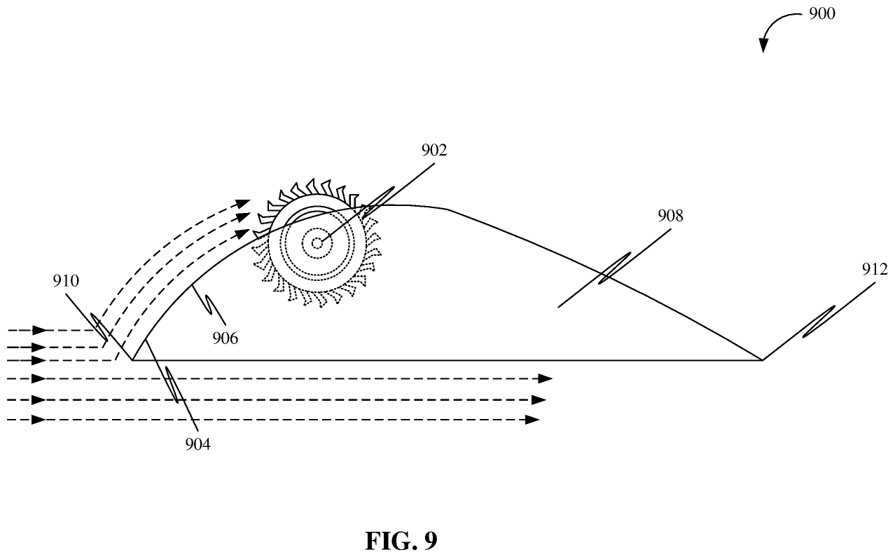

FIG. 9 is a top view of a windmill 900 with a half airfoil wing panel 908, in accordance with some embodiments. Further, the half airfoil wing panel 908 may include a leading edge 910, a trailing edge 912, two surfaces, and a varying thickness. Further, the half airfoil wing panel 908 may include the rotor assembly 902. Further, the rotor assembly 902 may include a rotor shaft and a plurality of blades (and/or scoops or scoops shaped profiles). Further, the half airfoil wing panel 908 may include a plurality of rotors in a lateral sequence along a plurality of parallel lines. Further, a curvature of the half airfoil wing panel 908 may be configured to accelerate flow of a wind. Further, at least one surface of the half airfoil wing panel 908 may include a wind interceptor portion 904 and at least one wind accelerator portion 906. Further, a first flow of the wind over the wind interceptor portion 904 may be lesser than a second flow of the wind over the at least one wind accelerator portion 906. Further, the rotor assembly 902 may partially protrude from at least one surface opening of the half airfoil wing panel 908. Further, the at least one surface opening may be associated with at least one surface proximal to the at least one wind accelerator portion 906. Further, the rotor assembly 902 may be located on a plane (such as a plane along outer surface of the half airfoil wing panel 908).

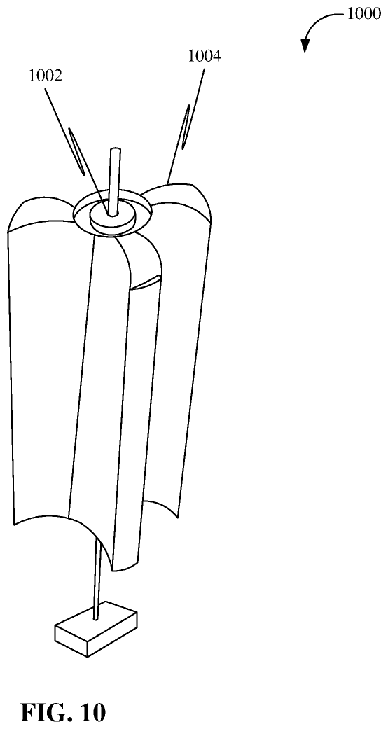

FIG. 10 is a top front perspective view of an elongated rotor assembly 1000 of a windmill, in accordance with some embodiments. Accordingly, the elongated rotor assembly 1000 may include an elongated rotor 1002 and a plurality of elongated blades 1004 (and/or scoops or scoop shaped profiles) that may extend along a length of the elongated rotor 1002.

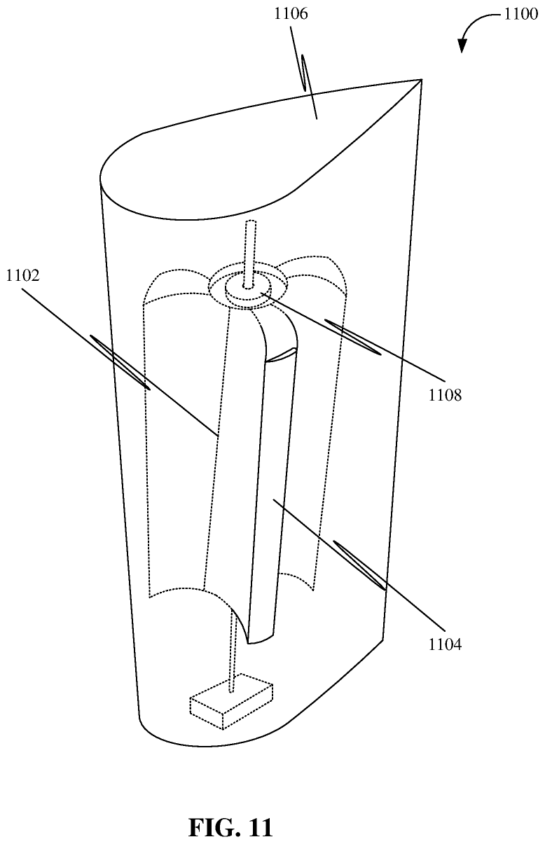

FIG. 11 is a top front perspective view 1100 of an elongated rotor assembly 1102 positioned inside a panel 1106, in accordance with some embodiments. Accordingly, the elongated rotor assembly 1102 may include an elongated rotor 1108 and a plurality of elongated blades 1104 (and/or scoops or scoop shaped profiles) that may extend along a length of the elongated rotor 1108.

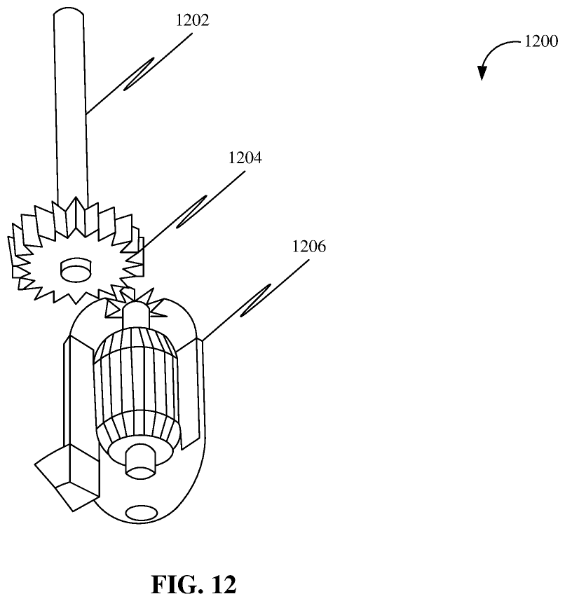

FIG. 12 is a schematic of an energy conversion mechanism 1200, in accordance with some embodiments. Accordingly, the energy conversion mechanism 1200 may include a drive shaft 1202, a gearbox 1204, and a generator 1206. Further, the drive shaft 1202 may be configured to transmit the rotational energy of one or more rotors to a generator 1206. Further, the generator 1206 may be configured to convert the rotational energy received through the drive shafts to electrical energy. Further, in an embodiment, the windmill may include an energy storage and transferring mechanism, such as a flywheel connected to the one or more rotors. Accordingly, the one or more rotors may transmit the rotational energy to the energy storage and transferring mechanism, whereupon the energy storage and transferring mechanism may transfer the rotational energy to a singular driveshaft connected to the generator 1206. Further, in an instance, the rotational speed of the one or more rotors may not be adequate to power the generator. Accordingly, the windmill may include a gearbox configured to increase rotational speed from the plurality of rotors to a higher speed, such as in a ratio of 90:1. Accordingly, a low rpm of 16.7 from the one or more rotors may be converted to 1,500 rpm output for the generator.

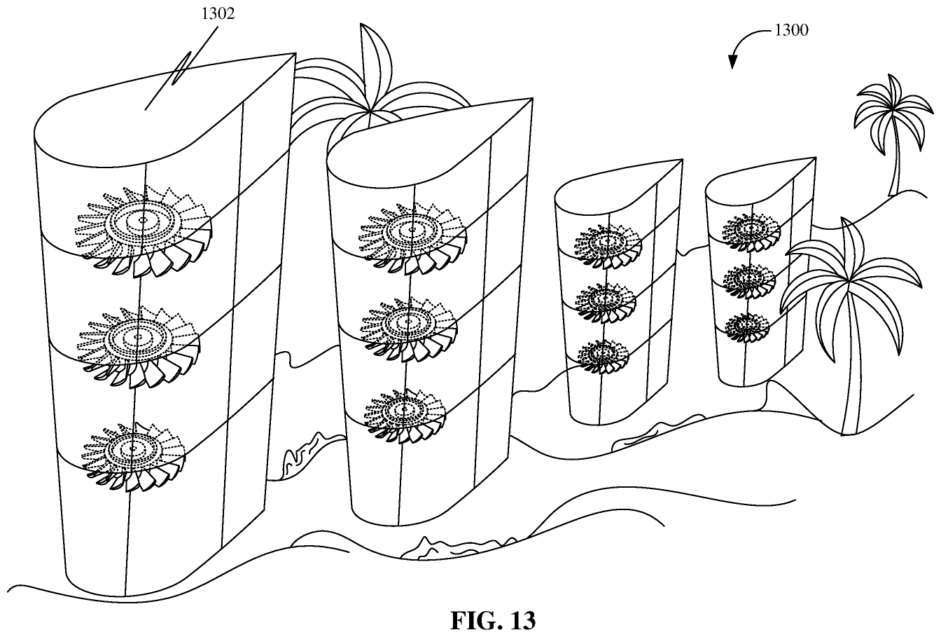

FIG. 13 is an illustration 1300 of installation of a windmill 1302 at a windmill farm, in accordance with exemplary embodiments. Accordingly, the windmill farm may include one or more cylindrical shaped windmills, kite shaped windmills, and so on. Further, the windmill farm may include an area with a desired wind speed, such as in an open area, an urban area, near the sea (or beach), and so on. Further, the windmill farm may incorporate an optimum use of land area by allowing a greater expansion of the one or more windmills vertically, causing lesser wind turbulence and fewer disturbances next to and behind each of the plurality of windmills. Further, the windmill farm may incorporate an optimized geometry due to reduced wind flow disturbances by the plurality of windmills allowing for a lighter and denser exploitation of available wind-rich areas.

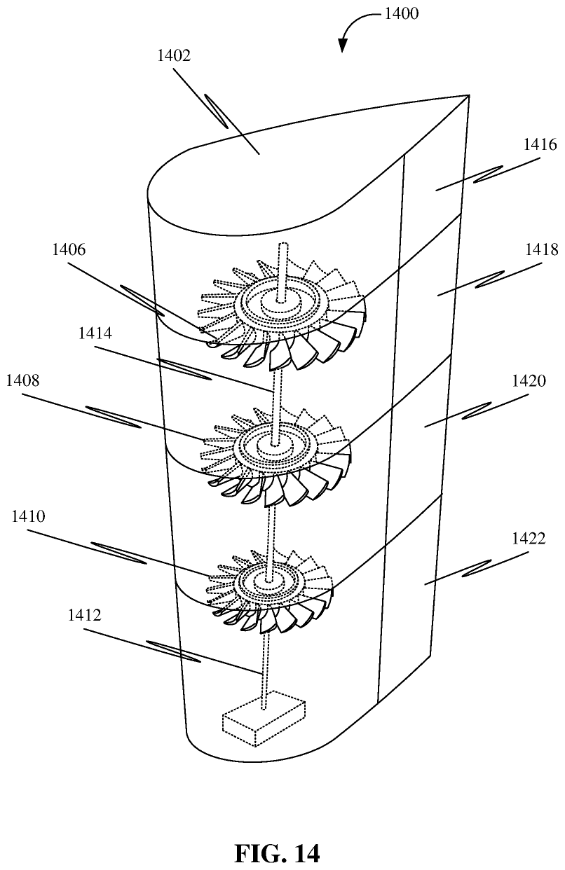

FIG. 14 is a windmill 1400 for harvesting energy from wind, in accordance with some embodiments. Accordingly, the windmill 1400 may include at least one rotor assembly 1412 and at least one panel 1402.

Further, the at least one rotor assembly 1412 may include a rotor shaft 1414 and a plurality of blades 1406-1410 disposed on the rotor shaft 1414. Further, the rotor shaft 1414 may be rotatable.

Further, the at least one panel 1402 may be movably disposed proximal to the at least one rotor assembly 1412. Further, the at least one panel 1402 may be disposed at a suitable distance proximal to the plurality of blades 1406-1410 associated with the at least one rotor assembly 1412. Further, the suitable distance may range up to 1 meter based on the size of the windmill. Further, the at least one panel 1402 may be arranged in at least one panel configuration. Further, the at least one panel configuration may include an enclosure. Further, the enclosure may be made up of metal, concrete, etc. Further, the at least one rotor assembly 1412 may be disposed within the enclosure. Further, a curvature of the at least one panel 1402 may be configured to accelerate flow of a wind. Further, at least one surface of the at least one panel 1402 may include a wind interceptor portion and at least one wind accelerator portion. Further, the at least one panel 1402 may be configured to move through a plurality of panel positions. Further, a panel position of the plurality of panel positions may align the wind interceptor portion along a direction of the flow of the wind. Further, the panel position may include orientation of the at least panel 1402 along the wind direction that may facilitate higher rotation of the at least one rotor assembly 1412. Further, the higher rotation of the at least one rotor assembly 1412 may facilitate harvesting more energy from the wind. Further, the at least one surface area may include at least one surface opening proximal to the at least one wind accelerator region. Further, a first flow of the wind over the wind interceptor portion may be lesser than a second flow of the wind over the at least one wind accelerator portion. Further, the at least one rotor assembly 1412 may be associated with the at least one wind accelerator portion. Further, at least one blade of the plurality of blades 1406-1410 may intercept the second flow of the wind through the at least one surface opening.

Further, in some embodiments, the at least one panel 1402 may be configured to arrange in a shut arrangement and an open arrangement. Further, the at least one blade may not intercept the second flow of the wind in the shut arrangement. Further, the at least one blade may intercept the second flow of the wind in the open arrangement.

Further, the at least one rotor assembly 1412 may be configured to orient in at least one orientation. Further, the at least one orientation may align a wind impact portion of the plurality of blades 1406-1410 perpendicular to the second flow of the wind. Further, the wind impact portion may include a segment of a blade of the plurality of blades 1406-1410 that may be first struck by the wind. Further, the perpendicular orientation of the at least one rotor assembly 112 may facilitate achieving higher rotational speed by the at least one rotor assembly. Further, the higher rotational speed of the at least one rotor assembly may facilitate harvesting more energy from the second flow of the wind.

Further, the at least one panel configuration may include a wing-shaped configuration. Further, the at least one surface may include at least one airfoil surface. Further, the flow of the wind accelerates over the at least one airfoil surface.

In further embodiments, the windmill 1400 may include at least one wind direction sensor disposed on the at least one panel. Further, the at least one wind direction sensor may be configured to generate at least one wind direction data. Further, in the at least one wind direction may correspond with the direction of the flow of the wind.

In further embodiments, the windmill 1400 may include a processor communicatively coupled with the at least one wind direction sensor. Further, the processor may be configured for generating panel data based on the at least one wind direction data.

In further embodiments, the windmill 1400 may include at least one actuator communicatively coupled with the processor. Further, the at least one actuator may be associated with the at least one panel. Further, the at least one actuator may be configured for moving the at least one panel through the plurality of panel positions based on the panel data.

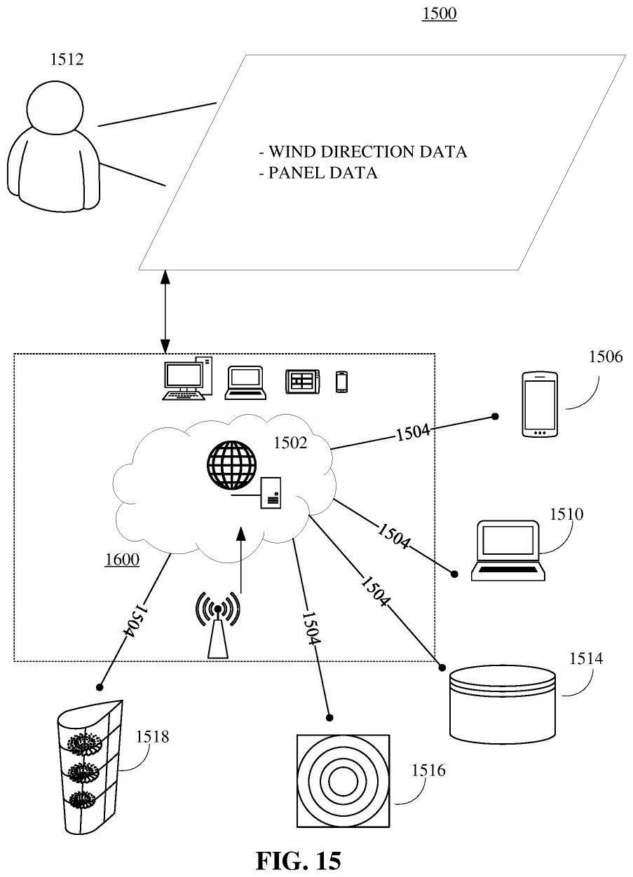

FIG. 15 is an illustration of an online platform 1500 consistent with various embodiments of the present disclosure. By way of non-limiting example, the online platform 1500 to facilitate the harvesting energy from wind may be hosted on a centralized server 1502, such as, for example, a cloud computing service. The centralized server 1502 may communicate with other network entities, such as, for example, a mobile device 1506 (such as a smartphone, a laptop, a tablet computer etc.), other electronic devices 1510 (such as desktop computers, server computers etc.), databases 1514, and sensors 1516 over a communication network 1504, such as, but not limited to, the Internet. Further, users of the online platform 1500 may include relevant parties such as, but not limited to, end-users, administrators, service providers, service consumers and so on. Accordingly, in some instances, electronic devices operated by the one or more relevant parties may be in communication with the platform.

A user 1512, such as the one or more relevant parties, may access online platform 1500 through a web based software application or browser. The web based software application may be embodied as, for example, but not be limited to, a website, a web application, a desktop application, and a mobile application compatible with a computing device 1600.

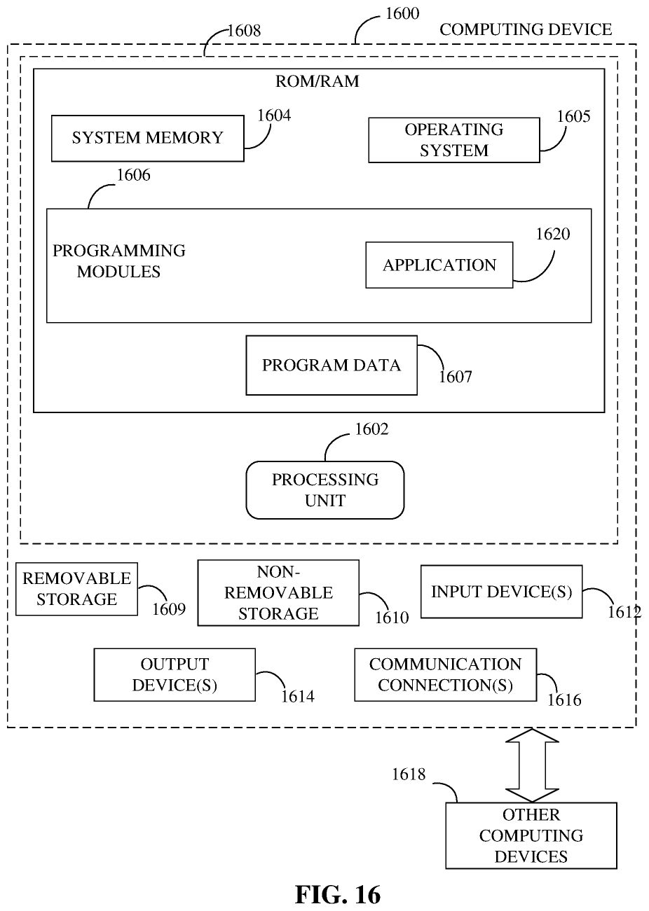

With reference to FIG. 16, a system consistent with an embodiment of the disclosure may include a computing device or cloud service, such as computing device 1600. In a basic configuration, computing device 1600 may include at least one processing unit 1602 and a system memory 1604. Depending on the configuration and type of computing device, system memory 1604 may comprise, but is not limited to, volatile (e.g. random-access memory (RAM)), non-volatile (e.g. read-only memory (ROM)), flash memory, or any combination. System memory 1604 may include operating system 1605, one or more programming modules 1606, and may include a program data 1607. Operating system 1605, for example, may be suitable for controlling computing device 1600's operation. Furthermore, embodiments of the disclosure may be practiced in conjunction with a graphics library, other operating systems, or any other application program and is not limited to any particular application or system. This basic configuration is illustrated in FIG. 16 by those components within a dashed line 1608.

Computing device 1600 may have additional features or functionality. For example, computing device 1600 may also include additional data storage devices (removable and/or non-removable) such as, for example, magnetic disks, optical disks, or tape. Such additional storage is illustrated in FIG. 16 by a removable storage 1609 and a non-removable storage 1610. Computer storage media may include volatile and non-volatile, removable and non-removable media implemented in any method or technology for storage of information, such as computer-readable instructions, data structures, program modules, or other data. System memory 1604, removable storage 1609, and non-removable storage 1610 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1600. Any such computer storage media may be part of device 1600. Computing device 1600 may also have input device(s) 1612 such as a keyboard, a mouse, a pen, a sound input device, a touch input device, a location sensor, a camera, a biometric sensor, etc. Output device(s) 1614 such as a display, speakers, a printer, etc. may also be included. The aforementioned devices are examples and others may be used.

Computing device 1600 may also contain a communication connection 1616 that may allow device 1600 to communicate with other computing devices 1618, such as over a network in a distributed computing environment, for example, an intranet or the Internet. Communication connection 1616 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1604, including operating system 1605. While executing on processing unit 1602, programming modules 1606 (e.g., application 1620 such as a media player) may perform processes including, for example, one or more stages of methods, algorithms, systems, applications, servers, databases as described above. The aforementioned process is an example, and processing unit 1602 may perform other processes.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

The following is claimed:

1. A windmill for harvesting energy from wind, the windmill comprising:
at least one rotor assembly comprising a rotor shaft and a plurality of blades disposed on the rotor shaft, wherein the rotor shaft is rotatable; and
at least one panel disposed proximal to the at least one rotor assembly, wherein a curvature of the at least one panel is configured to accelerate flow of a wind, wherein at least one surface of the at least one panel comprises a wind interceptor portion and at least one wind accelerator portion, wherein a first flow of the wind over the wind interceptor portion is lesser than a second flow of the wind over the at least one wind accelerator portion, wherein the at least one rotor assembly is associated with the at least one wind accelerator portion, wherein at least one blade of the plurality of blades intercepts the second flow of the wind.

2. The windmill of claim 1, wherein the at least one panel is movably disposed proximal to the at least one rotor assembly, wherein the at least one panel is configured to arrange in a shut arrangement and an open arrangement, wherein the at least one blade does not intercept the second flow of the wind in the shut arrangement, wherein the at least one blade intercepts the second flow of the wind in the open arrangement.

3. The windmill of claim 1, wherein the at least one surface comprises at least surface opening proximal to the at least one wind accelerator portion, wherein the at least one rotor assembly partially protrudes from the at least one surface opening exposing at least one first blade of the plurality of blades to the flow of the wind and concealing at least one second blade of the plurality of blades from the flow of the wind, wherein the at least one first blade intercepts the second flow of the wind, wherein the at least one second blade does not intercepts the second flow of the wind.

4. The windmill of claim 1, wherein the at least one panel is movably disposed proximal to the at least one rotor assembly, wherein the at least one panel is configured to move through a plurality of panel positions, wherein a panel position of the plurality of panel positions aligns the wind interceptor portion along a direction of the flow of the wind.

5. The windmill of claim 1, wherein the rotor shaft comprises a plurality of rotor shaft sections, wherein each rotor shaft section of the plurality of rotor shaft sections is retractable, wherein the each rotor shaft section is configured to transition between an extended position and a retracted position, wherein the at least one blade is disposed on the each rotor shaft section.

6. The windmill of claim 1, wherein the at least one panel comprises a plurality of panel sections, wherein each panel section of the plurality of panel sections is retractable, wherein the each panel section is configured to transition between an extended position and a retracted position.

7. The windmill of claim 1, wherein the at least one panel comprises a first panel and a second panel, wherein the first panel disposed proximal to the second panel comprising at least one panel gap, wherein the flow of the wind accelerates in the at least one panel gap due to tunnel effect, wherein the at least one gap associated with the at least one surface.

8. The windmill of claim 1, wherein the at least one panel comprises a curved surface and an interior space formed by the at least one panel, wherein the at least one rotor assembly is disposed within the interior space, wherein the curved surface comprises at least one surface opening proximal to the at least one wind accelerator portion, wherein the at least one blade protrudes from the at least one surface opening to intercept the second flow of the wind.

9. The windmill of claim 1, wherein the rotor shaft of a first rotor assembly of the at least one rotor assembly associated with a first wind accelerator portion of the at least one wind accelerator portion is configured to rotate in a clockwise direction, wherein the rotor shaft of a second rotor assembly of the at least one rotor assembly associated with a second wind accelerator portion of the at least one wind accelerator portion is configured to rotate in a counter-clockwise direction.

10. The windmill of claim 1, wherein the at least one rotor assembly is configured to orient in at least one orientation, wherein the at least one orientation aligns a wind impact portion of the plurality of blades perpendicular to the second flow of the wind.

11. The windmill of claim 1, wherein the at least one panel is configured in a cylindrical configuration, wherein the at least one surface comprises at least one airfoil surface, wherein the flow of the wind accelerates over the at least one airfoil surface.

12. The windmill of claim 1, wherein the at least one panel is configured in a kite-shaped configuration, wherein the at least one surface comprises at least one airfoil surface, wherein the flow of the wind accelerates over the at least one airfoil surface.

13. The windmill of claim 1, wherein the at least one panel is configured in a wing-shaped configuration, wherein the at least one surface comprises at least one airfoil surface, wherein the flow of the wind accelerates over the at least one airfoil surface.

14. A windmill for harvesting energy from wind, the windmill comprising:
at least one rotor assembly comprising a rotor shaft and a plurality of blades disposed on the rotor shaft, wherein the rotor shaft is rotatable; and
at least one panel movably disposed proximal to the at least one rotor assembly, wherein the at least one panel arranged in at least one panel configuration, wherein the at least one panel configuration comprises an enclosure, wherein the at least one rotor assembly is disposed within the enclosure, wherein a curvature of the at least one panel is configured to accelerate flow of a wind, wherein at least one surface of the at least one panel comprises a wind interceptor portion and at least one wind accelerator portion, wherein the at least one panel is configured to move through a plurality of panel positions, wherein a panel position of the plurality of panel positions aligns the wind interceptor portion along a direction of the flow of the wind, wherein the at least one surface area comprises at least one surface opening proximal to the at least one wind accelerator region, wherein a first flow of the wind over the wind interceptor portion is lesser than a second flow of the wind over the at least one wind accelerator portion, wherein the at least one rotor assembly is associated with the at least one wind accelerator portion, wherein at least one blade of the plurality of blades intercepts the second flow of the wind through the at least one surface opening.

15. The windmill of claim 14, wherein the at least one panel is configured to arrange in a shut arrangement and an open arrangement, wherein the at least one blade does not intercept the second flow of the wind in the shut arrangement, wherein the at least one blade intercepts the second flow of the wind in the open arrangement.

16. The windmill of claim 14, wherein the at least one rotor assembly is configured to orient in at least one orientation, wherein the at least one orientation aligns a wind impact portion of the plurality of blades perpendicular to the second flow of the wind.

17. The windmill of claim 14, wherein the at least one panel configuration comprises a wing-shaped configuration, wherein the at least one surface comprises at least one airfoil surface, wherein the flow of the wind accelerates over the at least one airfoil surface.

18. The windmill of claim 14 further comprises at least one wind direction sensor disposed on the at least one panel, wherein the at least one wind direction sensor is configured to generate at least one wind direction data, wherein in the at least one wind direction corresponds with the direction of the flow of the wind.

19. The windmill of claim 18 further comprises a processor communicatively coupled with the at least one wind direction sensor, wherein the processor is configured for generating panel data based on the at least one wind direction data.

20. The windmill of claim 19 further comprises at least one actuator communicatively coupled with the processor, wherein the at least one actuator is associated with the at least one panel, wherein the at least one actuator is configured for moving the at least one panel through the plurality of panel positions based on the panel data.
